(19) United States
(12) Patent Application Publication
(10) Pub. No.: US 2019/0202078 A1
(43) Pub. Date: Jul. 4, 2019

(54) Method for Cutting Out Coating Plates for Use in Digital Printing Units

(71) Applicant: Tresu A/S, Bjert (DK)

(72) Inventor: Erik GYDESEN, Vejle (DK)

(73) Assignee: Tresu A/S, Bjert (DK)

(21) Appl. No.: 16/303,224

(22) PCT Filed: May 22, 2017
(86) PCT No.: PCT/DK2017/050166

§ 371 Date: Nov. 20, 2018

(30) Foreign Application Priority Data
May 20, 2016 (DK) PA 2016 70339

(51) Int. Cl. B26F 1/38; B41J 11/70

(52) U.S. Cl. CPC B26F 1/3813; B41J 11/703

(57) ABSTRACT

Method for cutting out coating plates for use in digital printing units. A method for cutting out coating plates for use in digital printing units, where the cutting of coating plates is effected by means of a digital cutting machine, the cutting machine including a computer control and further including a mother roller, the method including at least the following steps: •a file including at least cutting data is transferred to the computer control of the digital cutting machine; •a sleeve with coating plate material is mounted on the mother roller of the cutting machine; •the coating plate mounted on the sleeve and the mother roller are cut out in the ratio 1:1 whereby is achieved, among others, that a mounting machine is no longer necessary in order to apply coating material on a sleeve, whereby registering accuracy is increased and shrinking effect is avoided.

This application claims the benefit of Danish Application No. PA 2016 70339 filed May 20, 2016 and PCT/DK2017/050166 filed May 22, 2017, International Publication No. WO 2017/198277 A1, which are hereby incorporated by reference in their entirety as if fully set forth herein.

### FIELD OF THE INVENTION

The present invention concerns a method for cutting out coating plates for use in digital printing units, where the cutting of coating plates is effected by means of a digital cutting machine, the cutting machine including a computer control and further including a mother roller. The invention also concerns a digital cutting machine for cutting out coating plates, the cutting machine being computer controlled.

### BACKGROUND OF THE INVENTION

It is known to cut out coating plates on plane cutting tables by means of digital cutting machines that are computer controlled and where a file for a given cut can be transferred to the computer which by means of software is able to edit, check and control the cutting machine as well as the cutting process on a cutting table.

A plate that is cut out on a plane cutting table is subsequently to be mounted on a sleeve by means of a mounting machine by which there may or will arise a small registering error, typically +/−0.5 mm.

Apart from the work procedure with the mounting machine there are also circumstances to be counted with when considering a plate cut out on a plane cutting table. For example, the shrinking effect is to be allowed for where a plane cut out plate mounted on a sleeve is stretched and becomes longer on the side of the plate facing away from the sleeve compared with the side of the plate facing inwards against the sleeve. If no allowance is made for the shrinking, the plate will print farther than specified in the cutting file.

The drawbacks of the shrinking effect may be attempted to be compensated for in the repro-work, but with varying diameters of the used sleeves, the compensation is therefore also different from sleeve dimension to sleeve dimension.

U.S. Pat. No. 5,713,288A discloses a digital cutting machine for cutting out plates for offset machines, where the cutting machine is computer controlled and where the cutting machine comprises a roller on which the plate material is fastened. This technology does not use sleeves, these can simply not be put on the machine, and consequently much machine time is used for changing and mounting. When sleeves are not used, the plate can therefore not readily be transferred to the mother roller of a printing unit, and consequently 100% registering will not exist by this method.

### OBJECT OF THE INVENTION

It is an object of the invention to avoid the work process of mounting a cut plate on a sleeve by means of a mounting machine.

It is also an object of the invention to increase the speed from the reception of an order and transfer of the customer's cutting file to the computer of the digital cutting machine until the fully functional plate is located in the coating machine of a production line, where the coating machine follows a digital printing unit, or where the coating machine can stand separately.

It is also an object of the invention to completely eliminate the disadvantages of shrinking whereby shrinking is not to be compensated for, hereby also ensuring a better result and a more accurate registering of coating by partial coating, and such that coating is not inadvertently applied the parts of a print that is to be used for gluing later. If there is any coating on these gluing areas, the glue will not hold and the production can be discarded.

It is also an object of the invention to save some of the plate material by only laying plate material on the required sections of a sleeve, i.e. the areas where a plate is actually to be placed. It is also an object to save coating by not applying coating on that areas of a print that are not to be used, i.e. the areas to be discarded after a punching procedure.

Finally, it is an object of the invention to improve the register function as the same digital file used for cutting out the plate is used in connection with printing as well, and the plate will therefore both be located correctly and fit to the digital print, and consequently the coating can furthermore be applied to the print with greater accuracy with less waste as a result as the cut sleeves are transferred directly to the coating unit.

### DESCRIPTION OF THE INVENTION

According to a first aspect of the invention, the above indicated objects are achieved by a method for cutting out coating plates for use in digital printing units as described by introduction and indicated in the preamble of claim 1, where the cutting of coating plates is effected by means of a digital cutting machine, the cutting machine including a computer control and further including a mother roller, the method including at least the following steps:

a file including at least cutting data is transferred to the computer control of the digital cutting machine;

tape is fitted on a sleeve;

the coating plate material is mounted on the sleeve;

the sleeve with coating plate material is mounted on the mother roller of the cutting machine;

the coating plate mounted on the sleeve and the mother roller is cut out in the ratio 1:1.

In this context, by computer control is meant that the cutting machine comprises hardware and software capable of converting data supplied to the cutting machine, that being e.g. from a USB stick, other storage medium or from a file transmitted by internet, to cutting work in relation to a coating plate. Preferably, the data from a file include a large amount of data, including i.a. sub-files with printing file and cutting file.

By the method is preferably used already prepared sleeves with fitted plate materials for mounting such a sleeve on a mother roller, after which the cutting out of the plate occurs while the plate is on the mother roller.

This implies a higher and optimal registering accuracy whereby the plate ensures that the register fits the print so that the plate only applies coating on the print. The plate is stripped after cutting.

The mounting step is therefore skipped as the coating plate with the sleeve is mounted directly on the mother roller of the printing unit to which the sleeve fits and whereby 100% registering accuracy is achieved.

By this method is also achieved, among others, the advantage that the entire step regarding traditional mounting of plane cut plates whereby plates are to be fitted with sleeves subsequently can be skipped, and whereby the plates cut out on the mother roller eliminate the drawbacks of shrinking, irrespectively of the selected mother roller diameter.

Based on the cutting data of the file, the coating plate is cut out in the ratio 1:1, i.e. without shrinking factor, and the coating plate will thus fit 100% when mounted on the mother roller in the printing unit.

By this method the coating plate will not be lopsided, and as mentioned it is not be cut with a shrink factor and therefore no shrinking effect is present, and the sleeve can therefore be transferred from the mother roller of the digital cutting machine to the mother roller of a digital printing unit without alignment, adaptation, adjustment, or other time-consuming work.

A very rapid change is possible as well as a plate can be made quickly in this way. Also, an improved economy will be an important factor as a result of saved coating and saved plate material.

The method is rapid, easy and efficient and can be performed “on demand” where an already prepared sleeve with coating plate material is put on the mother roller, being immediately ready for cutting out and subsequent use on a printing machine.

When using this method there is no need for a mounting machine, and a number of sleeves with plate material can be prepared in beforehand for cutting, thereby advancing the process a step further when the customer order enters the house and the customer's cutting file is entered in the cutting machine.

In a further aspect the present invention also concerns a digital cutting machine for cutting out coating plates, the cutting machine being computer controlled, where the cutting machine includes a mother roller for sleeves, where tape is fitted on the sleeve and where the coating plate material is mounted on the sleeve.

Based on a customer file, this will enable cutting out a coating plate from a previously prepared sleeve with tape and with coating plate material put on, digitally for cutting and stripping the coating plate for the desired task, after which the coating plate is ready to enter production, whereby the customer file also can be used in a facility for digital colour printing of sheets, and where the new coating plate can be used for subsequent coating the desired areas of the printed sheet, after which the sheet can be punched and glued at the areas that are not applied coating. As the same file is used for making digital colour print and coating plate, the plate therefore is located correctly and fits the print from the digital printing.

By stripping is meant removal of plate material from the sleeve not to be used when applying coating. For example, a strippable plate or a polymer plate.

Therefore it is possible to put a previously prepared sleeve with plate material on the mother roller, after which the cutting machine can initiate cutting the coating plate after receiving the cutting file. The process from start to finish including stripping can be performed in a few minutes. This is very important as digital printing can e.g. change job up to 50 times a day, so-called “on demand”, where relatively small series are run on few sheets, after which printing file and sleeve are to be changed.

The mother roller can rotate and therefore move clockwise or counterclockwise, respectively, and in any combination thereof, controlled and checked by the computer of the cutting machine, and so that the cutter head with knife primarily performs a linear movement along the mother roller, or the cutter head with knife stands still and the mother roller rotates, but it is also possible that the cutter head with knife can move along the mother roller while at the same time the mother roller rotates whereby curving shapes can be cut out. The mother roller can be replaced and change diameter according to wish and need; alternatively, adapter systems and/or sleeves with different material thickness can be used.

Traditionally, plane-cut plates are mounted on sleeves after cutting, where the plane-cut plates are shrunk in the repro such that they after mounting on a round sleeve fit the print file. By cutting the plate directly on a sleeve mounted on the mother roller, this problem is eliminated as cutting is performed one-to-one from file to plate.

By coatings is meant all kinds of aqueous coating, silver, gold and other metallic coatings, UV-based varnishes, common protective coatings as well as matt varnishes and varnishes with sheen, respectively, and flexographic inks.

In a further aspect, the present invention also concerns a cutting machine for cutting out coating plates, the cutting machine including a first side, a second side, a third side, a fourth side and a top, the first side including a tape cylinder and a sleeve cylinder, and the second side including the mother roller.

This enables transferring and drawing tape from a tape roll put on a tape cylinder to a sleeve put on a sleeve cylinder, where the two cylinders are parallel such that the tape can be rolled on at once and without waste when the tape roll and the sleeve have the same length. In a preferred embodiment, the tape cylinder is disposed farthest from the cutting machine and the sleeve cylinder closest to the cutting machine, whereby it is possible to put on tape from one side of the sleeve cylinder while the sleeve cylinder is rotated in one direction, e.g. clockwise, and then put on plate material from the other side of the sleeve cylinder while the sleeve cylinder is rotated in the opposite direction, e.g. counterclockwise, meaning that the plate material can lie on top of the cutting machine from where it can be put on or rolled on.

In a further aspect, the present invention also concerns a digital cutting machine for cutting out coating plates, the third side of the cutting machine including a plate storage compartment.

This enables making of a small stock of e.g. four sleeves with plate material put on in beforehand such that these sleeves are prepared and ready to be put on the mother roller, and the plates are cut out. Space is thereby utilised optimally, and an order from a customer can be executed quickly.

Alternatively, the prepared sleeves with plate material can of course be stored in other cabinets, preferably in the area where the cutting machine is located.

In a further aspect, the present invention also concerns a digital cutting machine for cutting out coating plates wherein the cutting machine further includes at least one cutter beam and at least one cutter head, and where the cutting machine further includes means for moving the cutting machine.

In a preferred embodiment, the cutter head includes a knife that is rotatable as a wheel on a base, the knife at the same time being rotatable about a substantially vertical axis, whereby the cutter head thus enables cutting out plates in curving shape by simultaneous movement of cutter beam, mother roller and cutter head.

This enables moving the cutting machine and the cutter head in different directions and combinations of directions by means of means that are preferably electrically powered.

In a further aspect, the present invention also concerns a digital cutting machine for cutting out coating plates, wherein the cutting machine is movable at least along a first axis and a second axis, where the first axis is parallel with the mother roller and substantially horizontal, and where the second axis is perpendicular to the first axis and substantially vertical.

This will further enable moving the cutting machine in direction of the first axis as well as of the second axis, which preferably will be in longitudinal direction of the mother roller and in an upward and downward movement, which are cutting patterns that can be assumed by the cutting machine.

In an further aspect, the present invention also concerns a digital cutting machine for cutting out coating plates, wherein at least one cutter beam is disposed in the direction of the first axis, and the at least one cutter head is disposed in the direction of the second axis and movable in the direction of the first axis along the cutting boom as well as in the direction of the second axis towards/away from the mother roller.

This will further enable moving the at least one cutter head of the cutting machine in direction of the first axis as well as of the second axis, which preferably will be along the cutter beam and in parallel with the mother roller and in an upward and downward movement, preferably perpendicular to the mother roller, which are cutting patterns that may be assumed by the cutter head during rotating movement or alternating back and forth movements of the mother roller.

### DESCRIPTION OF THE DRAWING

FIG. 1 shows a digital cutting machine for cutting out coating plates, in perspective view;

FIG. 2 shows a sleeve with cut out and stripped plate.

### LIST OF DESIGNATIONS

1 digital cutting machine
2 computer
3 display
4 keyboard
5 mouse
6 pressing roller
7 mother roller for sleeves, mother roller
8 first side
9 second side
10 third side
11 fourth side
12 top
13 tape cylinder
14 sleeve cylinder
15 plate storage compartment
16 cutter beam
17 cutter head
18 moving means
19 first axis
20 second axis
21 rotational direction
23 sleeve
24 plate/coating plate
25 plate material

### DETAILED DESCRIPTION OF EMBODIMENTS OF THE INVENTION

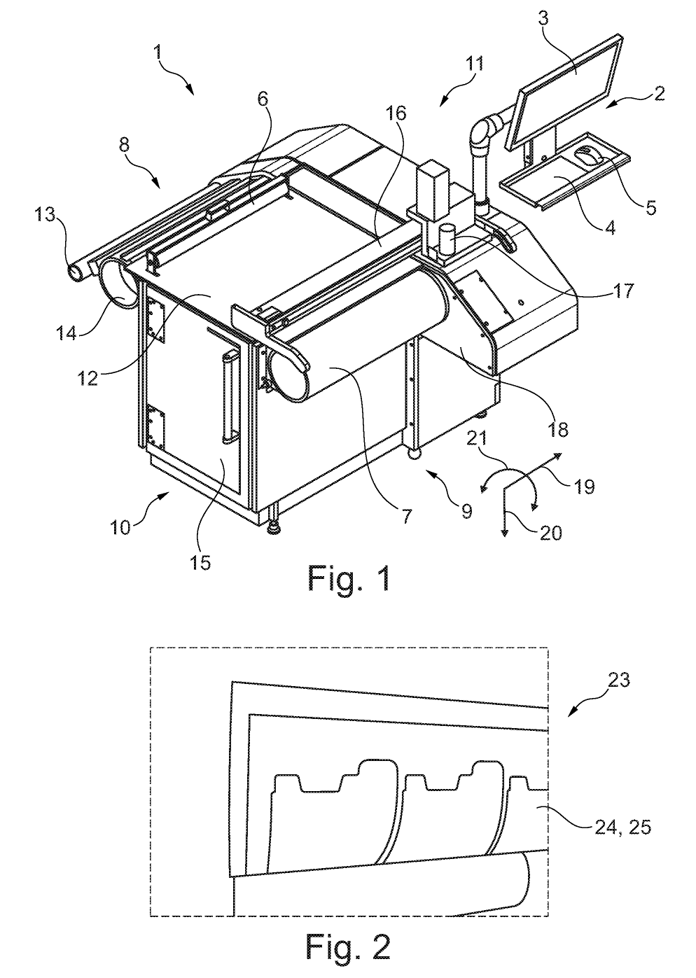

FIG. 1 shows a digital cutting machine 1 for cutting coating plates in perspective view, where the cutting machine 1 is equipped with a computer 2 located in the cutting machine 1, and in the shown example provided with a display 3 with a keyboard 4 and a mouse 5 for use in operating the computer 2 and thereby the cutting machine 1. The cutting machine 1 also includes a mother roller 7 for sleeves.

The Figure also shows that the cutting machine 1 has a first side 8, a second side 9, a third side 10, a fourth side 11 and a top 12, the first side 8 including a tape cylinder 13 and a sleeve cylinder 14, and wherein the second side includes the mother roller 7, whereas the third side 10 includes a plate storage compartment 15.

On the Figure is also seen a manual pressing roller 6 for use in mounting plate material, whereby the pressing roller 6 is moved to the sleeve cylinder 14, having the purpose of ensuring that the plate material 25 is correctly placed on the sleeve 23.

The cutting machine 1 has a cutter beam 16 and a cutter head 17, and the cutting machine 1 furthermore has moving means 18 for moving i.a. cutter beam 16, cutter head 17 and mother roller 7 of the cutting machine.

In order to understand the moving pattern of the cutting machine, two axes are drawn on the Figure, a first axis 19, a second axis 20 and a direction of rotation 21, all of which being described in more detail in the following.

The cutting machine 1 is at least movable along the first axis 19 and the second axis 20, wherein the first axis 19 is parallel with the mother roller 7 and substantially horizontal, wherein the second axis 20 is perpendicular to the first axis 19 and substantially vertical.

As it appears on the Figure, the cutter beam 16 is disposed in direction of the first axis 19, whereas the cutter head 17 is disposed in direction of the second axis 20, wherein the cutter head 17 is movable both in direction of the first axis 19 and along as well as in parallel with the mother roller 7 and in direction of the second axis 20 down against or up from the mother roller 7.

The direction of rotation 21 indicates the directions of rotation of mother roller 7, tape cylinder 13 and sleeve cylinder 14, which are all substantially parallel.

FIG. 2 shows an example of a sleeve 23 wherein the sleeve 24 is cut out and stripped and ready for entering into production, wherein the plate 24 now has the shape that enables precise application of coating on a print, without coating being applied on anything else than the print and only on the parts of the print on which coating is desired, and therefore not on parts of the print that possibly are to be glued together.

1. A method for cutting out coating plates for use in digital printing units, where the cutting of coating plates is effected by means of a digital cutting machine, the cutting machine including a computer control and further including a mother roller, wherein the method includes at least the following steps:
a file at least comprising cutting data is transferred to the computer control of the digital cutting machine;
tape is fitted on a sleeve;
the coating plate material is mounted on the sleeve;
the sleeve with coating plate material is mounted on the mother roller of the cutting machine;
the coating plate mounted on the sleeve and the mother roller is cut out in the ratio 1:1.

2. (canceled)

3. A digital cutting machine for cutting out coating plates, the cutting machine being computer controlled, wherein the cutting machine at least includes a mother roller for sleeves that tape is fitted on the sleeve and that the coating plate material is mounted on the sleeve.

4. A digital cutting machine for cutting out coating plates according to claim 3, wherein the cutting machine comprises a first side, a second side, a third side, a fourth side and a top, the first side including a tape cylinder and a sleeve cylinder, and that the second side includes the mother roller.

5. A digital cutting machine for coating plates according to claim 3, wherein the third side of the cutting machine includes a plate storage compartment.

6. A digital cutting machine for coating plates according to claim 3, wherein the cutting machine further includes at least one cutter beam and at least one cutter head, and that the cutting machine further includes means for moving the cutting machine.

7. A digital cutting machine for coating plates according to claim 3, wherein the cutting machine is movable at least along a first axis and a second axis, where the first axis is parallel with the mother roller and substantially horizontal, and where the second axis is perpendicular to the first axis and substantially vertical.

8. A digital cutting machine for coating plates according to claim 3, wherein at least one cutter beam is disposed in the direction of the first axis, and that the at least one cutter head is disposed in the direction of the second axis and is movable in the direction of the first axis along the cutter beam as well as in the direction of the second axis towards/away from the mother roller.
